(19) United States
(12) Patent Application Publication
(10) Pub. No.: US 2003/0235019 A1
(43) Pub. Date: Dec. 25, 2003

(54) Electrostatic discharge protection scheme for flip-chip packaged integrated circuits

(76) Inventors: Ming-Dou Ker, Hsinchu (TW); Wen-Yu Lo, Taichung Hsien (TW)

Correspondence Address: MERCHANT & GOULD PC, P.O. BOX 2903, MINNEAPOLIS, MN, 55402-0903, US

(21) Appl. No.: 10/175,071

(22) Filed: Jun. 19, 2002

(51) Int. Cl. H02H 9/00

(52) U.S. Cl. 361/56

(57) ABSTRACT

An electrostatic discharge (ESD) protection scheme. The scheme utilizes traces in a package substrate to bridge a power ESD clamp circuit and a protected circuit, and comprises a conductive trace in a package substrate and a chip die. The chip die has a protected circuit powered by a first high power rail and a first low power rail, and a power ESD clamp circuit coupled between a second high power rail and a second low power rail. The first high, first low, second high and second low power rails are all fabricated on the IC chip die. The first high power rail is separated from the second high power rail on the chip die, and, during an ESD event, is coupled to the second high power rail through the conductive trace in the package substrate.

### BACKGROUND OF THE INVENTION

1. Field of the Invention

The present invention relates to an electrostatic discharge (ESD) protection scheme. In particular, the present invention relates to an ESD protection scheme employing a trace on a package substrate to connect an ESD clamp circuit and a protected circuit.

2. Description of the Related Art

ESD protection is an important reliability issue in integrated circuit (IC) industry. Concerning on-chip ESD protection design, VDD-to-VSS ESD clamp circuits are widely used to protect core or input/output (I/O) circuits from damage by ESD stress, as shown in FIG. 1. VDD or VSS pads (18a and 18b) are suggested to couple to VDD-to-VSS ESD clamp circuits (40 or 44) in a chip die 20 to protect the core or I/O circuits (38 or 42) from damage in every combination of ESD stress in the ESD test.

FIG. 2 shows an exemplary placement for I/O circuits, VDD-to-VSS ESD clamp circuits, and core circuits in a traditional packaged IC chip die. A chip die 20 of a traditional packaged IC has I/O circuits 38 at the periphery and core circuits 42 at the central area. Due to the considerable resistance of the power rails in a chip die, every VDD-to-VSS ESD clamp circuit 40 can only protect a limited number of nearby I/O circuits 38 or pads. Therefore, additional VDD-to-VSS ESD clamp circuits 40 must sometimes be inserted between I/O circuits 38 as shown in FIG. 2.

As pin counts of the ICs and speeds of I/O circuits increase, flip chip package technique becomes more popular. Unlike traditional packaged ICs, bonding wires are not used to connect the pads on the chip die with the package. The flip chip package technique uses solder bumps to connect the pads on the chip die with the package. With the flip chip technique, pads can be placed directly on I/O or core circuits and can contribute very low parasitic inductance after connecting the pads and the package. Taking advantage of flip chip package technique, many VDD or VSS pads can be placed directly on I/O or core circuits for better signal integrity and power distribution. In such a configuration, if every VDD-to-VSS ESD clamp circuit still protects a limited number of nearby pads, placing VDD-to-VSS ESD clamp circuit in the central area will become common and, as a result, will consume a very large silicon area and increase the difficulty for auto-place-and-route (APR). If not, the core circuit becomes even more susceptible to ESD stress.

### SUMMARY OF THE INVENTION

An object of the present invention is to eliminate limitations due to considerable resistance of the power rails in an IC chip die.

Another object of the present invention is to increase flexibility for the design of ESD protection in the flip chip IC.

The ESD protection scheme of the present invention includes a conductive trace in a package substrate and a chip die. The chip die includes a protected circuit and a power ESD clamp circuit. The protected circuit is powered by a first high power rail and a first low power rail. The power ESD clamp circuit is coupled between a second high power rail and a second low power rail. All power rails are fabricated on the chip die. The first high power rail is separated from the second high power rail on the IC chip die. Nevertheless, during an ESD event, the first high power rail is coupled to the second high power rail through the first conductive trace in the package substrate.

The first low power rail is coupled to the second low power rail through another conductive trace in the package substrate, or, alternatively, is connected to the second low power rail without a route outside the IC chip die.

In comparison with the routes provided only by the conductive strips, typically having a thickness less than 1 um, the conductive traces on the package substrate typically have a thickness of several tens um to hundreds um. Therefore, each conductive trace in the package substrate can provide a much less-resistant route to bridge the power rails in the chip die than that provided only by the conductive strips in the chip die. Each power ESD clamp circuit, as a result, can protect much more I/O circuits or pads. As a result, the number of ESD clamp circuits can be reduced to save silicon area and cost.

Furthermore, employing the bridge of the conductive traces in the package substrate, ESD clamp circuits have much more flexibility to be placed in the chip die.

### BRIEF DESCRIPTION OF THE DRAWINGS

The present invention can be more fully understood by reading the subsequent detailed description in conjunction with the examples and references made to the accompanying drawings, wherein:

FIG. 1 shows a conventional ESD protection scheme utilizing metal strips on a chip die to connect VDD-to-VSS ESD protection circuits with I/O or core circuits;

FIG. 2 shows an exemplary placement for I/O circuits, VDD-to-VSS ESD clamp circuits, and core circuits in a traditional packaged IC chip die;

FIG. 3 shows an ESD protection scheme of the present invention for core or I/O circuits;

FIG. 4 shows the ESD protection scheme of the present invention for a chip die that has separated power rail pairs corresponding to I/O and core circuits, respectively;

FIG. 5 shows two ESD protection schemes for the ESD stress across different power rail pairs;

FIG. 6 shows the combination of the ESD protection schemes in FIGS. 4 and 5;

FIG. 7 shows an alternative ESD protection scheme design for the ESD stress across different power rail pairs;

FIG. 8 shows an ESD protection system according to the present invention; and

FIGS. 9 and 10 are two top views of the pad arrangement for two chip dies.

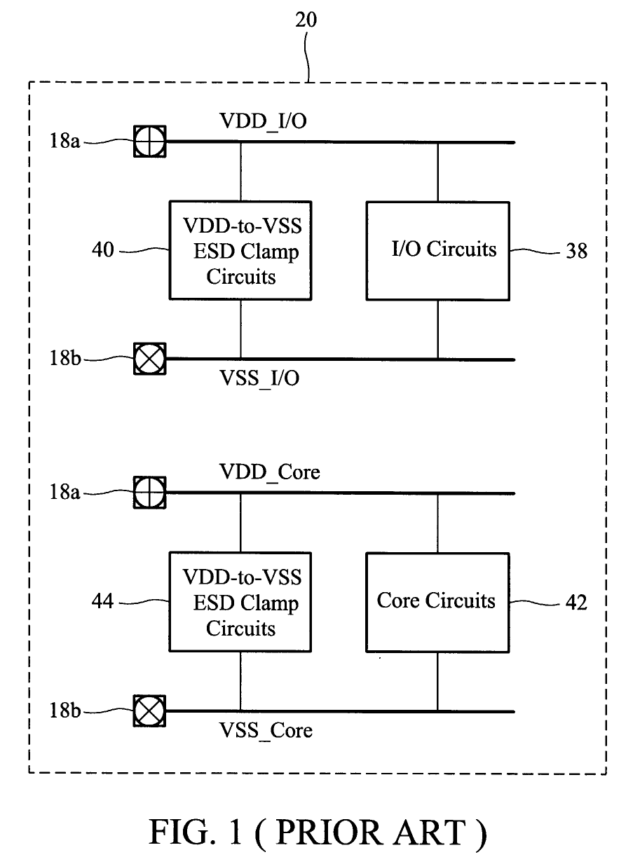

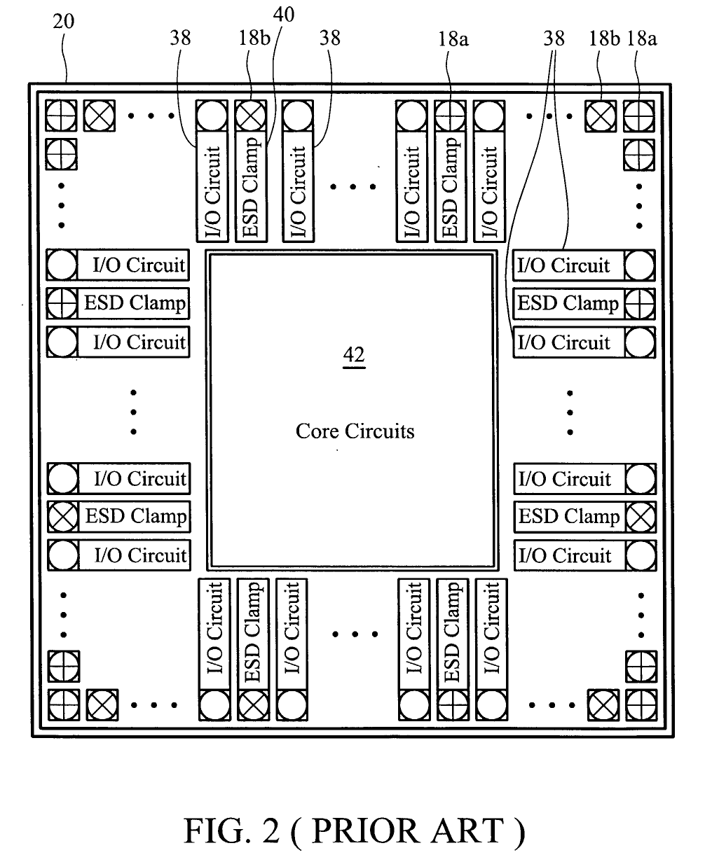

### DETAILED DESCRIPTION OF THE INVENTION

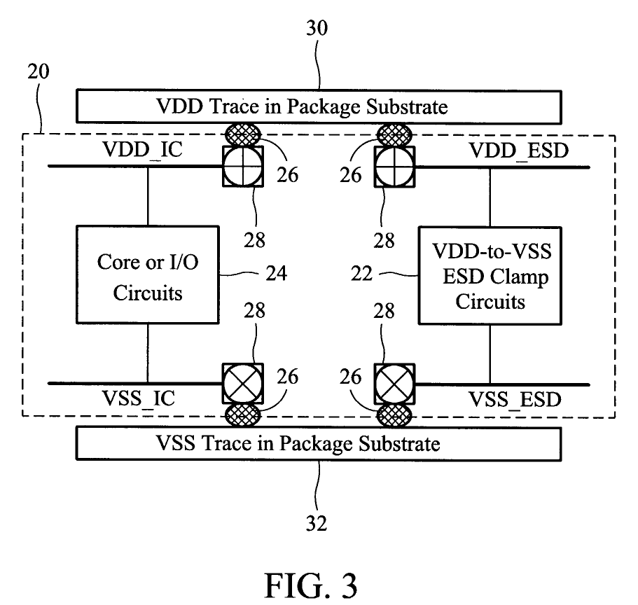

FIG. 3 shows an ESD protection scheme for core or I/O circuits. In a chip die 20, there are VDD-to-VSS ESD clamp circuits 22 and core and I/O circuits 24. VDD-to-VSS ESD clamp circuits 22 are coupled between two power rails, VDD_ESD and VSS_ESD, while the core or I/O circuits 24 are coupled between two power rails, VDD_IC and VSS_IC. Each power rail is connected to a power pad 28 formed with a solder bump 26. Before the chip die 20 is packaged, VDD_IC is separated from VDD_ESD, and VSS_IC is separated from VSS_ESD. Taking a flip chip device as an example, the chip die is mounted face down on a package substrate, such as a printed circuit board, and then attached to the package substrate by welding or soldering. VDD_trace 30 in the package substrate provides a route to bridge VDD_IC and VDD_ESD through the solder bumps 26, and, furthermore, connects them to a VDD pin of the package. Similarly, VSS trace 32 in the package substrate provides a route to bridge VSS_IC and VSS_ESD through the solder bumps 26, and, furthermore, connects them to a VSS pin of the package. Normally, on-chip metal lines, including power rails, have a line thickness of tens um, at most, depending on the manufacture specification. Designer can widen the line-width, but not the line-thickness. Traces in a package substrate have a line thickness from tens um to hundred um. Thus, at the same width, traces usually have much less parasitic resistance than the power rails.

In normal operation, electrical power comes from the VDD and VSS pins, and goes through VDD and VSS traces, VDD_IC and VSS_IC, to power the core and I/O circuits 24, while VDD-to-VSS ESD clamp circuits 22 are kept in off state. During an ESD event, such as positive ESD voltage on a VDD pin and a VSS pin is grounded, the ESD voltage or stress is first spread over the VDD trace 30 due to its lower resistance in comparison with that of the rails on the chip die 20. Before the core or I/O circuits 24 is damaged by the ESD stress, VDD-to-VSS ESD clamp circuits 22 are designed to be turned on by the high ESD stress, and provide a low-impedance path from VDD to VSS to discharge the ESD current and protect the chip die 20 from ESD damage.

In the ESD protection scheme of FIG. 3, VDD-to-VSS ESD clamp circuits 22 are not required to be close to the core or I/O circuits 24, as in the prior art. This flexibility allows the VDD-to-VSS clamp circuits to be placed at previously difficult-to-use locations so the overall silicon area of the chip die is not increased.

The benefit of the ESD protection scheme in FIG. 3 further includes the lower number of VDD-to-VSS ESD claim circuits 22 required to protect the core or I/O circuits 24, compared to those needed in the prior art. The number of the VDD-to-VSS ESD clamp circuits depends on the response speed of each VDD-to-VSS clamp circuit in every combination of ESD stress. If there is a combination in which all the VDD-to-VSS ESD clamp circuits respond too low to protect the core or I/O circuits, usually due to the considerable resistance of the power rails, an additional VDD-to-VSS ESD clamp circuit must be specially inserted and placed into the chip die. In the prior art, more I/O or core circuits imply more VDD-to-VSS ESD clamp circuits. Applying the present invention, no matter what combination of ESD stress is, it will quickly be spread over VDD trace 30 or VSS trace 32 because of the lower resistance of the traces in the package substrate to turn on the connected VDD-to-VSS ESD clamp circuits. Thus, every combination of ESD stress is almost the same in view of ESD response speed. Once the number of VDD-to-VSS clamp circuits is enough in consideration of ESD protection, it is still enough even if the number of the core or I/O circuits is increased.

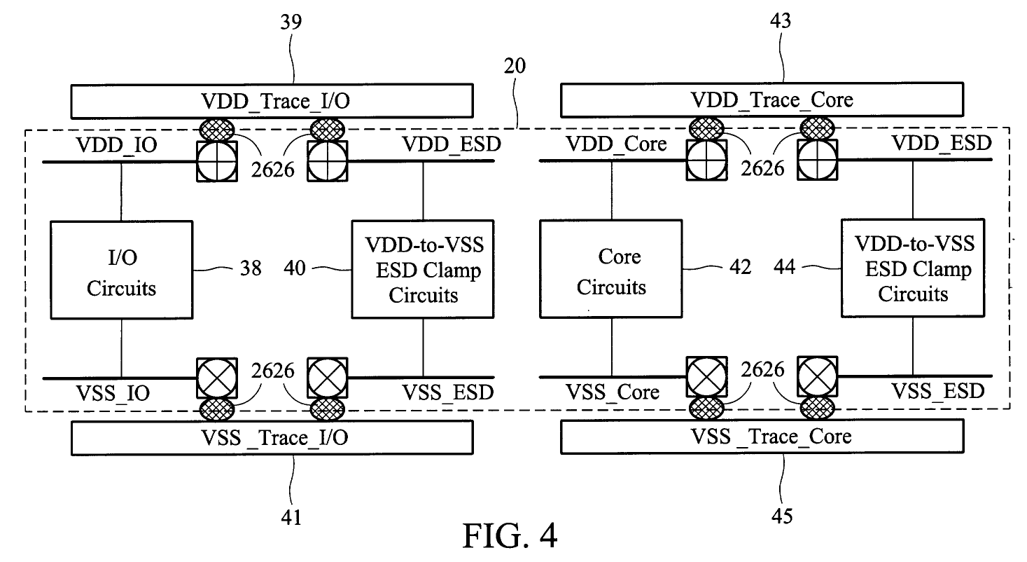

The pair of power rails for core circuits can always be separated from the pair of power rails for I/O circuits, as shown in FIG. 4, to prevent power bouncing or noise migration. FIG. 4 shows the ESD protection scheme of the present invention for a chip die that has separate power rail pairs corresponding to I/O and core circuits, respectively. The power rail pair, VDD_I/O and VSS_I/O, is specially provided for I/O circuits 38. The power rails pair, VDD_core and VSS_core, is specially provided for core circuits 42. VDD-to-VSS ESD clamp circuits 40 protect the I/O circuits 38 via solder bumps 26, VDD_trace_I/O 39 and VSS_trace_I/O 41. VDD-to-VSS ESD clamp circuits 44 protect the core circuits 42 via solder bumps 26, VDD_trace_core 43 and VSS_trace_core 45. The power bouncing induced by the high current driving in the I/O circuits 38 will not affect the core circuits 42 since the power rail pairs are separated.

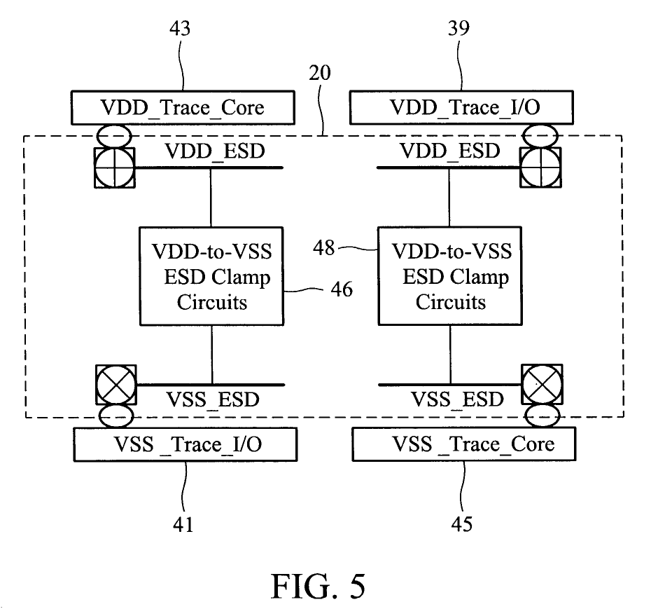

ESD protection must be provided in case of the ESD stress across different power rail pairs. FIG. 5 shows two ESD protection schemes for the ESD stress across different power rail pairs. VDD-to-VSS ESD clamp circuits 46 protect the ESD stress across the VDD pin for core circuits and the VSS pin for I/O circuits, and are coupled between VDD_trace_core 43 and VSS_trace_I/O 41. VDD-to-VSS ESD clamp circuits 48 protect the ESD stress across the VDD pin for I/O circuits and the VSS pin for core circuits, and are coupled between VDD_trace_I/O 39 and VSS_trace_core 45.

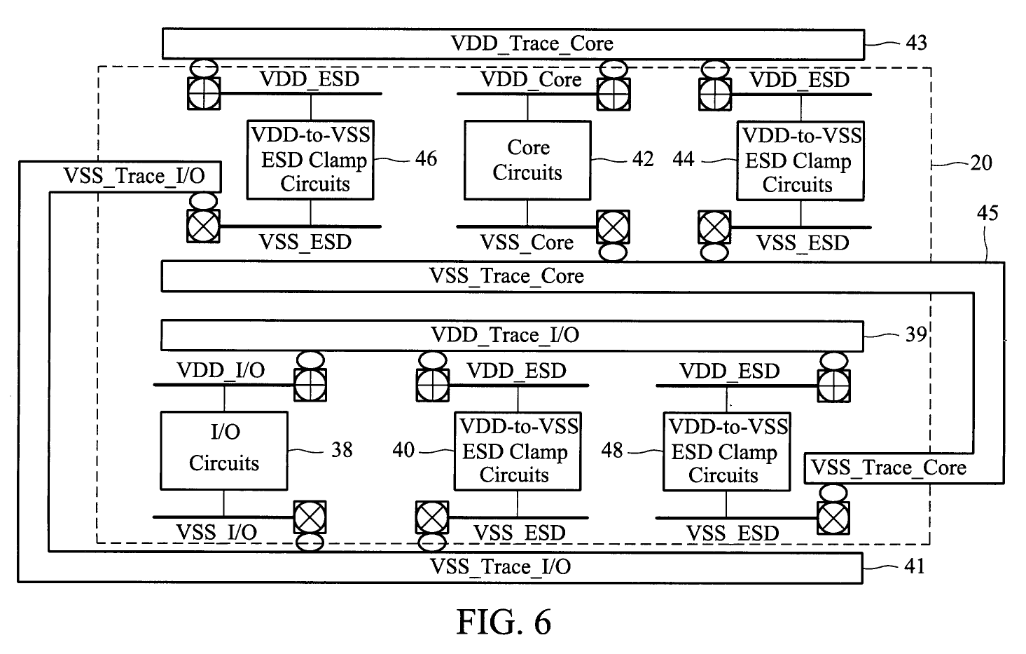

FIG. 6 shows the combination of the ESD protection schemes in FIGS. 4 and 5. Through the package substrate, the power rail pair of VDD_trace_core 43 and VSS_trance_core 45 is connected to the VDD and VSS pins (not shown) to substantially transmit power to the core circuits 42. The power rail pair of VDD_trace_I/O 39 and VSS_trance_I/O 41 is connected to the VDD and VSS pins to substantially transmit power to the I/O circuits 38.

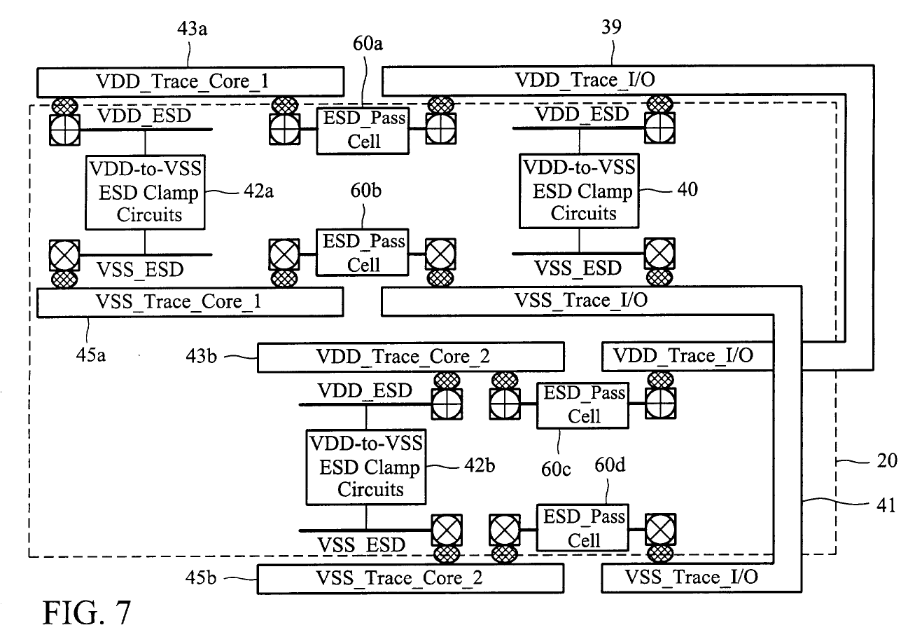

An alternative ESD protection scheme design for the ESD stress across different power rail pairs is shown in FIG. 7. To protect circuits powered by different power pins from ESD damage, ESD_pass cell(s) (60˜) can be inserted between traces for different power pins to construct a discharge route during an ESD event. One way to construct an ESD_pass cell is to connect two diodes in parallel but reverse direction. Thus, the anode and the cathode of one diode are respectively coupled to the cathode and the anode of another diode. Each diode can be composed of several diodes connected in series in order to have a higher threshold voltage. The threshold voltages of the two diodes depend on how much noise margin or voltage difference is acceptable between the two connected traces at normal operation condition. In FIG. 7, ESD_pass cells 60a, 60b, 60c and 60d are individually coupled between power traces. In normal operation, the voltage difference across the VDD_trace_core_1 43a and VDD_trace_I/O 39, for example, is not high enough to turn on the ESD_pass cell 60a. In an ESD event with positive voltage on VDD_trace_I/O 39 and ground voltage on VSS_trace_core_1 45a, there are at least two discharge routes in FIG. 7. One route starts from VDD_trace_I/O 39, passes through ESD_pass cell 60a, VDD_trace_core_1 43a, and VDD-to-VSS ESD clamp circuits 42a, and ends at VSS_trace_core_1 45a. The other route starts from VDD_trace_I/O 39, passes through VDD-to-VSS ESD clamp circuits 40, VSS_trace_I/O 41, and ESD_pass cell 60b, and ends at VSS_trace_core_1 45a. Between them, the route with the lowest turn-on voltage will be automatically selected to discharge the ESD stress.

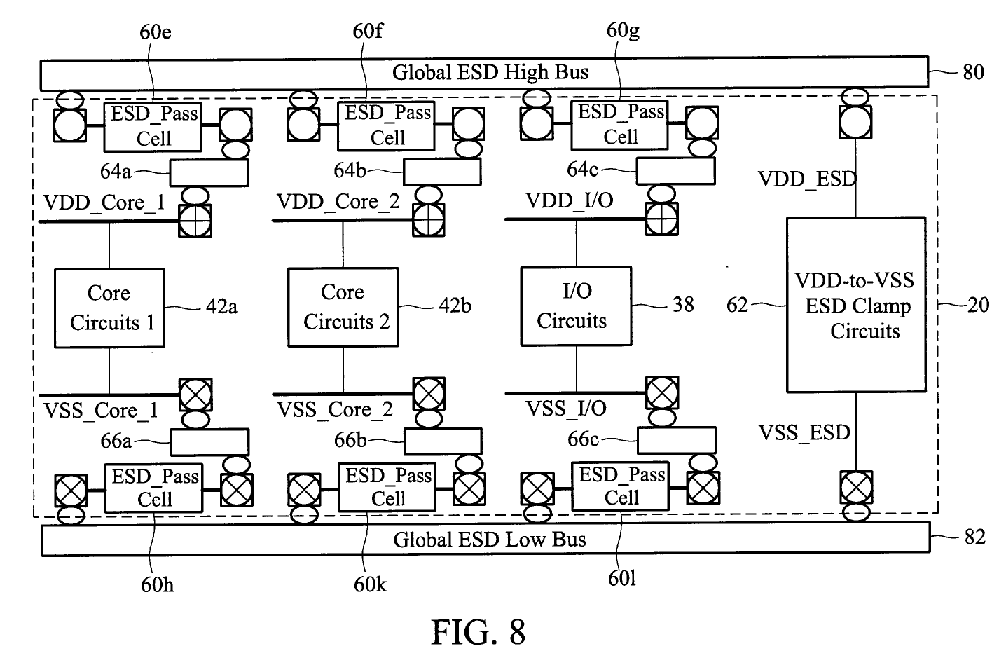

FIG. 8 shows an ESD protection system according to the present invention. In advanced IC chip, it is common to power different circuit groups with different power rail pairs connected to different power pins on the package. To meet the requirement of ESD protection for each combination of power pins, the ESD protection system in FIG. 8 is proposed. Core circuits 42a are powered by two power rails, VDD_core_1 and VSS_core_1. ESD_pass cell 60e is coupled to VDD_core_1 through a trace 64a in the package, and furthermore, coupled to a global ESD high bus 80, another trace in the package. ESD_pass cell 60h is coupled to VSS_core_1 through a trace 66a in the package, and furthermore, coupled to a global ESD low bus 82, another trace in the package. VDD-to-VSS ESD clamp circuits 62 are coupled between global ESD high and low buses (80 and 82). The similar connections are applied to core circuit 42b and I/O circuits 38. In normal operation, VDD-to-VSS ESD clamp circuits 62 and all ESD_pass cells function as open circuits. During ESD stress, they may be triggered on to act as short circuits to discharge the ESD stress. For example, if the ESD positive voltage pulses on trace 64a while trace 66b is grounded, the discharge current will sequentially go through trace 64a, ESD_pass cell 60e, global ESD high bus 80, VDD-to-VSS ESD clamp circuits 62, global ESD low bus 82, ESD_pass cell 60k and trace 66b.

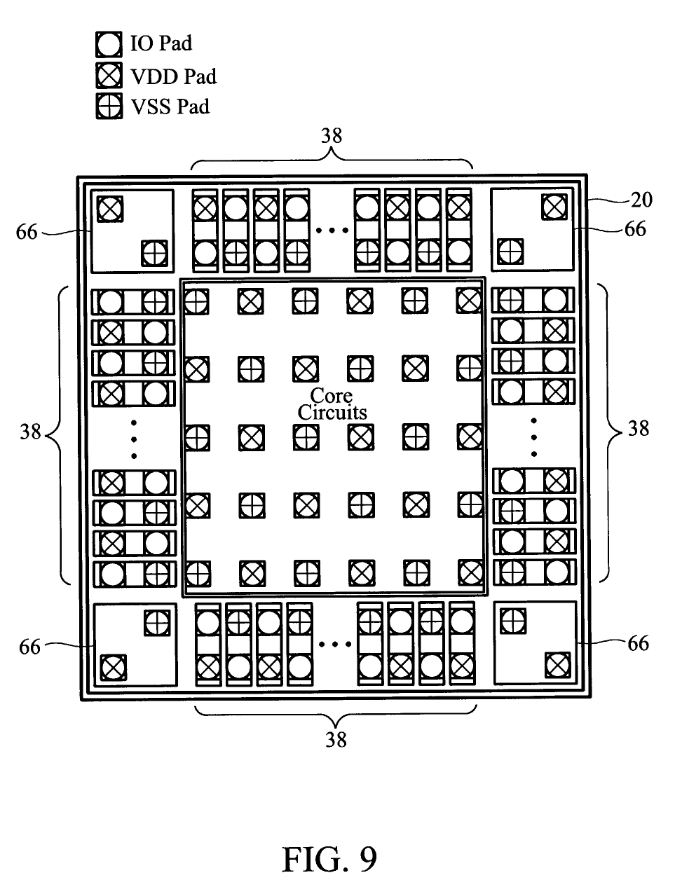

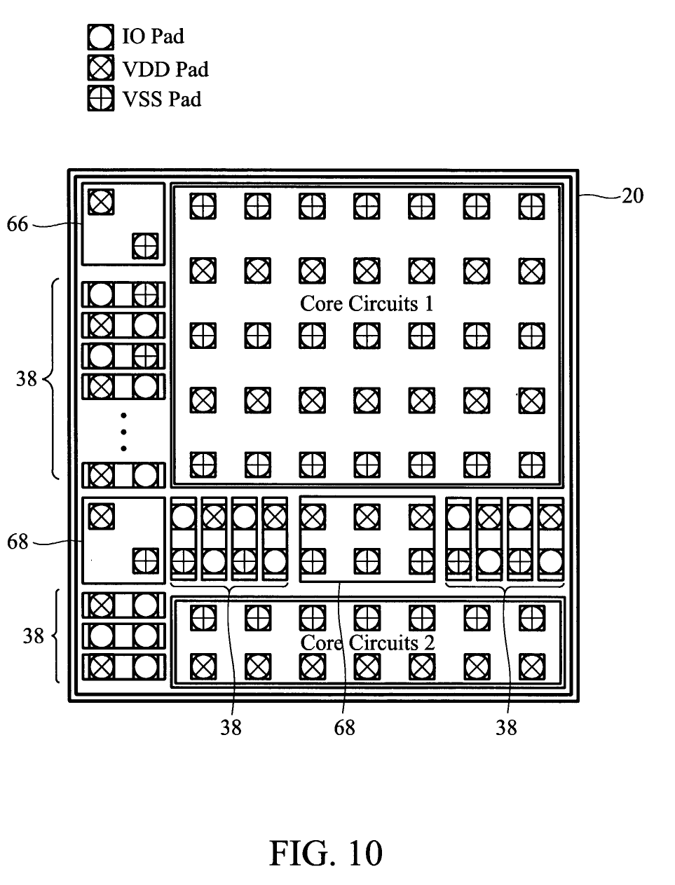

By applying the traces in package to connect VDD-to-VSS ESD clamp circuits with I/O or core circuits, designers have more flexibility to place pads on a chip die. FIGS. 9 and 10 are two top views of the pad arrangement for two chip dies. I/O circuits 38 are placed at all sides of the square chip die 20. What must be noticed is that, except an inevitable I/O pad, every I/O circuit has only one power pad, either VDD or VSS. The I/O circuit with a VSS/VDD pad is placed between two I/O circuits, each having a VDD/VSS pad. Of course, every I/O circuit must be powered through at least two power rails, for example, VDD and VSS. Every power rail in an I/O circuit is connected to a power trace via a power pad on the I/O circuit or on an adjacent I/O circuit. VDD-to-VSS ESD clamp circuit has two power pads thereon, which provide bridges to connect with the I/O or core circuits via the traces in the package substrate. In FIG. 9, all VDD-to-VSS ESD clamp circuits 66 are placed at the four corner regions. In FIG. 10, in addition to a VDD-to-VSS ESD clamp circuit 66 in a corner region, two VDD-to-VSS ESD clamp circuits 68 are located in the central region of a chip die 20. Several I/O circuits 38 are also placed in the central region to divide the core circuits into two groups, core circuits 1 and core circuits 2. All the core circuits have power pads thereon to connect their power rails with the power rails of the VDD-to-VSS ESD clamp circuits via the traces on the package substrate.

In comparison with the prior art, which uses metal strips in a chip die to connect VDD-to-VSS clamp circuits with I/O or core circuits, the ESD protection scheme of the present invention utilizes traces in the package substrate to bridge them. Due to less resistance, the VDD-to-VSS ESD clamp circuit can protect more I/O or core circuits, can be placed in any region to result a smaller die size, and to save cost.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. An electrostatic discharge (ESD) protection scheme, comprising:
a first conductive trace in a package substrate; and
a chip die, including:
a protected circuit powered by a first high power rail and a first low power rail, the first high and low power rails being fabricated on the chip die; and
a power ESD clamp circuit coupled between a second high power rail and a second low power rail, the second high and low power rails being fabricated on the chip die;
wherein the first high power rail is separated from the second high power rail on the chip die, and, during an ESD event, is coupled to the second high power rail through the first conductive trace in the package substrate.

2. The ESD protection scheme as claimed in claim 1, wherein the first low power rail is separated from the second low power rail on the chip die, and is coupled to the second low power rail through another conductive trace in the package substrate.

3. The ESD protection scheme as claimed in claim 1, wherein the first low power rail is separated from the second low power rail on the chip die, and is not coupled to the second low power rail after the chip die is packaged.

4. The ESD protection scheme as claimed in claim 1, wherein the protected circuit is an input/output circuit.

5. The ESD protection scheme as claimed in claim 1, wherein the protected circuit is a core circuit.

6. The ESD protection scheme as claimed in claim 1, wherein the first high, first low, second high and second low power rail are respectively coupled to a first high power pad, a first low power pad, a second high power pad and a second low power pad formed with bumps.

7. The ESD protection scheme as claimed in claim 1, wherein the ESD protection scheme further comprises a second conductive trace in the package substrate, and, the first and second conductive traces are respectively coupled to two pads of an ESD-pass cell that electrically separates the first and second conductive traces during normal operation but electrically connects the first and second conductive traces during ESD event.

8. The ESD protection scheme as claimed in claim 7, wherein, during an ESD event, the first high power rail is coupled to the second high power rail through the first conductive trace, the ESD-pass cell and the second conductive trace.

9. An electrostatic discharge (ESD) protection scheme, comprising:
a first conductive trace in a package substrate; and
a chip die, including:
a protected circuit powered by a first high power rail and a first low power rail, the first high and low power rails fabricated on the chip die; and
a power ESD clamp circuit coupled between a second high power rail and a second low power rail, the second high and low power rails fabricated on the chip die;
wherein the first low power rail is separated from the second low power rail on the chip die, and, during an ESD event, is coupled to the second low power rail through the first conductive trace in the package substrate.

10. A chip die, comprising:
an first I/O circuit with a first power rail, having a I/O pad and only one first power pad thereon, the first power pad coupled to the first power rail; and
a power ESD clamp circuit with a second power rail, having at least two second power pads thereon, one of the two second power pads coupled to the second power rail;
wherein, on the chip die, the first power rail is separated from the second power rail, but, through a trace on a package substrate, the first power pad is electrically connected to the second power rail.
